(19) United States
(12) Patent Application Publication
(10) Pub. No.: US 2013/0270399 A1
(43) Pub. Date: Oct. 17, 2013

(54) Management of Cables That Traverse Moving Robot Joints

(71) Applicants: Ben Berkowitz, Sharon, MA (US); Josiah Rosmarin, Cambridge, MA (US)

(72) Inventors: Ben Berkowitz, Sharon, MA (US); Josiah Rosmarin, Cambridge, MA (US)

(21) Appl. No.: 13/446,585

(22) Filed: Apr. 13, 2012

(51) Int. Cl. F16L 3/10; B23P 11/00

(52) U.S. Cl. 248/70; 248/65; 248/74.2; 29/428

(57) ABSTRACT

Rotation of a joint from a first angular position to a second angular position without damage to a cable therein utilizes a spirally wound cable in a space between inner and outer cylinders of the joint. In various embodiments, the cable is wrapped around an outer surface of the inner cylinder at the first angular position and unwrapped from the outer surface of the inner cylinder at the second angular position.

### FIELD OF THE INVENTION

Embodiments of the present invention generally relate to cable management and, in particular, to managing cables that traverse moving robot joints.

### BACKGROUND

A robotic system generally includes various electro-mechanical systems connected by cables. Due to the ever-increasing complexity of robotic systems, careful planning with regard to cable positioning and accommodation of joint movement is required as robotic cells are designed. In fact, due to increased reliability of mechanical components, cable failure has become a leading cause of for downtime in robotic systems. Cable management has therefore assumed greater prominence in the design phase.

In particular, cables passing through moving joints must accommodate the various mechanical displacements without excessive mechanical wear due; these displacements may alter the bending load of the cables and/or changes in their diameters due to twisting (or torsion) of the joints. For example, cables passing through robotic joints ideally have a large and uniform bend radius to minimize cable deformation and homogeneously distribute the bending load thereon. The large and uniform bend radius, however, may be difficult to achieve in a space-constrained package of the robotic system (e.g., the joints).

Conventionally, there are two approaches for arranging cables so as to accommodate robot joints. For a rotary joint, cables may be passed through the center of the joint in order to minimize displacement of the cables during joint movement. The cables may nonetheless be damaged due to the twisting (or torsion) that they experience, significantly reducing their lifetime. Additionally, this approach typically requires more space in the joint and/or special configurations of the joints for accommodating the cables, thereby increasing the system size, weight, and cost.

The other approach is to route the cable external to the joints. This approach may avoid the design difficulties of accommodating cables internally in the space-constrained package of the joints, but risks snagging the cables on an external object (e.g., a human operator) during joint movement. Consequently, there is a need for an approach to cable management that avoids cable damage without the need for custom support components.

### SUMMARY

In various embodiments, the present invention relates to systems and methods for facilitating cable passage through moving, space-constrained joints using a “clock-spring” cable management system. Compared with conventional cable management approaches, the systems and methods disclosed herein significantly reduce the space consumed by cables passing through the robotic joints without subjecting them to possible damage or requiring custom support components. A representative clock-spring system includes a cable wound spirally in a space between two cylinders that rotate relative to one another. The cable may be wrapped around the outer surface of the inner cylinder (inner mandrel) in one rotational direction and expanded against the inner surface of the outer cylinder (outer sleeve) in another rotational direction. Alternatively, one section of the cable may be wrapped around the outer surface of the inner cylinder while another section of the cable is unwrapped from the outer surface of the inner cylinder. This mechanism reduces cable length, system weight and cost. Because the bend radius of the cable is kept substantially large (i.e., larger than the outside diameter of the inner cylinder) and uniform (between the outside diameter of the inner cylinder and the inside diameter of the outer cylinder), the cable does not experience torsional stress and the bending stress applied thereto is significantly reduced. Additionally, the space occupied by the cables as they enter and/or exit the joint may be minimized using a folding design, which provides additional compactness.

Accordingly, in one aspect, the invention pertains to a cable-management system for facilitating rotation from a first angular position to a second angular position without damage to the cable. In various embodiments, the system includes inner and outer cylinders and a cable wound spirally in the space between the inner and outer cylinders. The outer cylinder or the inner cylinder may be rotatable relative to the other cylinder between the first angular position and the second angular position. In one embodiment, the inner and outer cylinders are concentric. In another embodiment, the rotational axis of the inner cylinder and that of the outer cylinder are offset with respect to each other. In various embodiments, the two cylinders include at least one retaining clip to confine lateral movement of the cable. At least a section of the cable may be configured to wrap around an outer surface of the inner cylinder at the first angular position and to unwrap from the outer surface of the inner cylinder at the second angular position.

The cable-management may further include a slot in the inner cylinder for a first end of the cable to twist and pass therethrough and a slot in the outer cylinder for the cable to pass therethrough and exit the outer cylinder at an angle of, for example, less than 45° relative to a plane tangent to the outer cylinder.

In a second aspect, the invention relates to a method of rotating a cable within a joint from a first angular position to a second angular position without damage to the cable. The joint has inner and outer cylinders capable of net relative rotation and the cable is wound spirally in a space between the inner and outer cylinders. In various embodiments, the method includes the steps of (i) executing a rotation of the joint in a first direction whereby at least a first section of the cable wraps around an outer surface of the inner cylinder, and (ii) executing a rotation of the joint in a second direction whereby the cable unwraps from the outer surface of the inner cylinder. In one embodiment, at least a second section of the cable unwraps from the outer surface of the inner cylinder in the first rotational direction and wraps around the outer surface of the inner cylinder in the second rotational direction. In some embodiments, at an end point of the rotation in the first direction, the cable is tightly wrapped around the outer surface of the inner cylinder. In some embodiments, at an end point of the rotation in the second direction, the cable is urged against the inner surface of the outer cylinder.

As used herein, the term “substantially” means ±10°, and in some embodiments, ±5°. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a perspective view of a robotic system including a bend joint and a twist joint;

FIG. 2A is a perspective view of an embodiment of a clock-spring cable-management system disposed within a bend joint;

FIG. 2B shows the embodiment of FIG. 2A with components removed to illustrate the configuration of the cable within the joint;

FIGS. 3A and 3B are perspective views of the top and bottom, respectively, of a clock-spring cable-management system disposed within a twist joint; and

FIGS. 3C and 3D show the views of FIGS. 3A and 3B, respectively, with components removed to illustrate the configuration of the cable within the joint.

### DETAILED DESCRIPTION

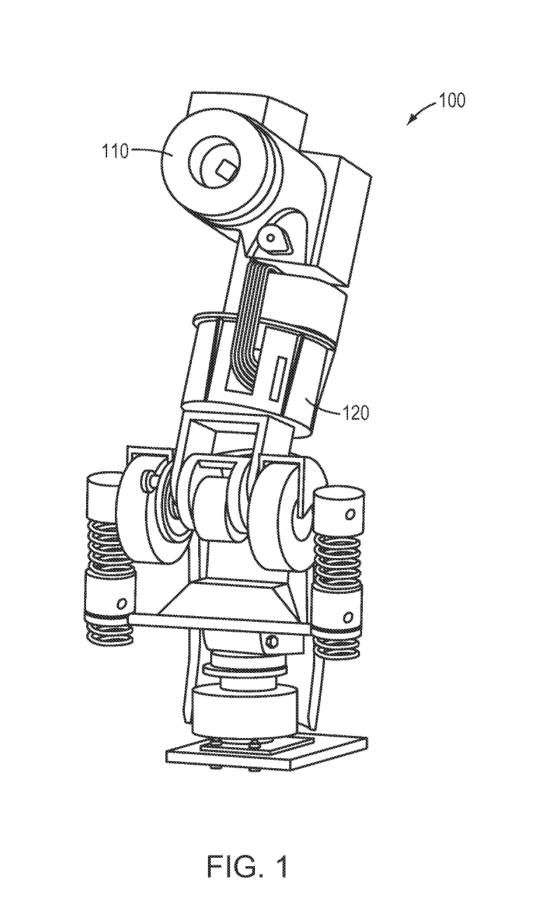

Refer first to FIG. 1, which illustrates a portion 100 of a robotic system having multiple types of joints, in particular a bend joint 110 and a twist joint 120. Each joint may have different characteristics, freedom of movement (e.g., range of motion or degrees of freedom), and/or package space; therefore, cable-management systems passing through the joints generally require special designs adapted to the particular joint type. For example, cables may pass through a bend joint 110 in a manner that affords a large bending stiffness, while cables passing through twist joints may be configured to sustain a large twisting deformation. In accordance with embodiments of the present invention, the same basic configuration may be applied both to the bend joint 110 and the twist joint 120. The way in which cables are folded to enter and/or exit the cable-management system may be modified to conform to the various packaging spaces of different joint types. This may avoid damaging the cables and thus maximizes their lifetime.

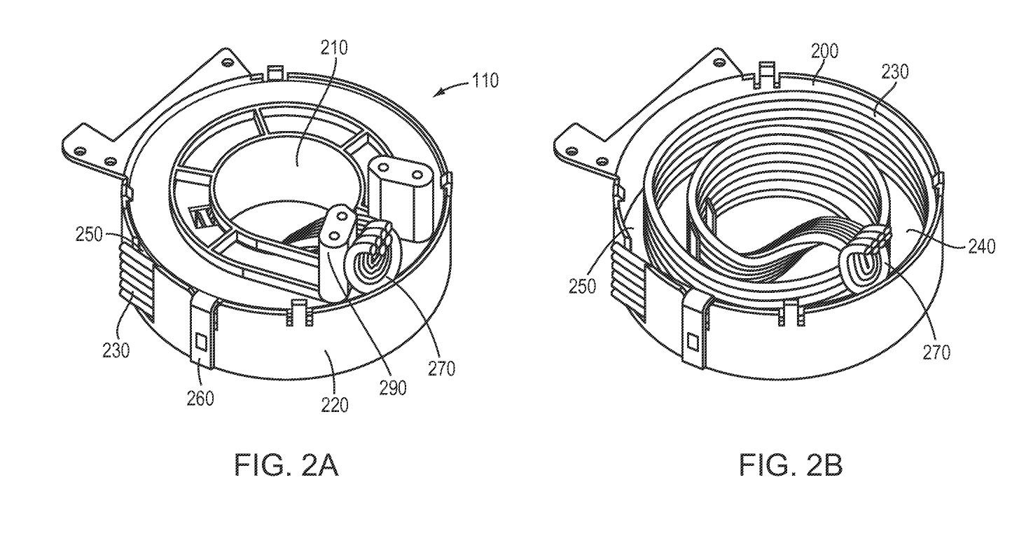

With reference to FIG. 2A, a clock-spring cable-management system 200 may be used to pass cables through a bend joint 110. The joint 110 includes two cylinders, namely, an inner cylinder (or inner mandrel) 210 and an outer cylinder (or outer sleeve) 220, which rotate relative to one another. As best seen in FIG. 2B, a cable 230 is wound spirally in the space 240 between the inner mandrel 210 and outer sleeve 220. In one embodiment, the inner mandrel 210 and outer sleeve 220 are concentric. When the joint 110 bends in one direction, the inner mandrel 210 is subject to rotation in one direction (for example, clockwise), whereas the outer sleeve 220 remains in a static position. The cable 230 wound in the space 240 may thus, in the case of net counterclockwise rotation of the inner mandrel 210, be drawn around (e.g., wrapping tightly against) the outer surface thereof. Similarly, when joint 110 bends in the other direction—i.e., in the case of net clockwise rotation of the inner mandrel 210—the cable 230 may expand against the inner surface of the outer sleeve 220.

In another embodiment, the rotational axis of the inner mandrel 210 is offset from that of the outer sleeve 220. When the inner mandrel 210 is subject to rotation in one direction, a first section of the cable 230 is wrapped against the outer surface thereof while a second section of the cable 230 is unwrapped therefrom. When the inner mandrel 210 is subject to rotation in another direction, the first section is unwrapped from the outer surface thereof while the second section is wrapped thereagainst. This mechanism significantly reduces the required cable length passing through the robotic joints, thereby reducing the system weight and cost. As used herein, the term “net rotation” of a member does not necessarily mean that the member itself rotates, merely that the effect on the cable is as if the member has rotated; for example, if the inner mandrel 210 remains static but the outer sleeve 220 rotates counterclockwise, the effect on the cable is the same as if the inner mandrel 210 has rotated clockwise, and this qualifies as a net clockwise rotation of the inner mandrel 210.

Because the cable 230 may either be pulled to wrap around the outer surface of the inner mandrel or expanded against the inner surface of the outer sleeve during joint bending, the bend radius of the cable 230 is maintained within a range, i.e., between the outside diameter of the inner mandrel 210 and the inside diameter of the outer sleeve 220. This bend radius is large and substantially uniform over the length of the spiral, and even when the cable expands or contracts, the spiral uniformity is preserved and the overall bend radius never varies by more than the distance between the inner mandrel 210 and the outer sleeve 220; this allows the cable survive many cycles of bending.

Although the present discussion assumes that at least one of the cylinders is rotatable relative to the other during joint bending, the present invention is not limited to such movements. One of ordinary skill in the art will understand that the illustrated cable configuration may accommodate different movements causing the cable spiral to expand or contract.

Because the packaging space of the bend joint may be limited and the cable may be stiff, a compact cable folding design as the cable enters and/or exits the joint 110 may be employed. With continued reference to FIGS. 2A and 2B, the outer sleeve 220 may include a slot 250 for cable 230 to enter the joint 110. Because the cable 230 passes through the slot 250 with a relatively small angle (e.g., less than 45°) relative to the surface of the outer sleeve 220, the space used for cable entry is minimized. The cable-management system 200 may further include a retaining clip 260 attached to the outer sleeve 220 to constrain the lateral movement of the cable 230 and thereby reduce the space it occupies. Similarly, the inner mandrel 210 may include a slot (not shown) for cable 230 to exit the joint 110. To minimize the space needed to permit cable exit, the cable 230 may first pass vertically through the slot in the inner mandrel and then twist 90° so as to exit the joint 110 horizontally. FIG. 2B illustrates that twist may elevate the exiting cable so it passes over and out of the joint 110. The elevated height in one embodiment is one cable width. However, other exiting and twisting angles and elevated heights that provide a folding approach for the cable to exit the clock-spring system 200 within a compact space are within the scope of the current invention. In various embodiments, the elevated cable further forms a small loop 270 before extending away from the joint 110, allowing lateral cable movement to be confined by a projection 290.

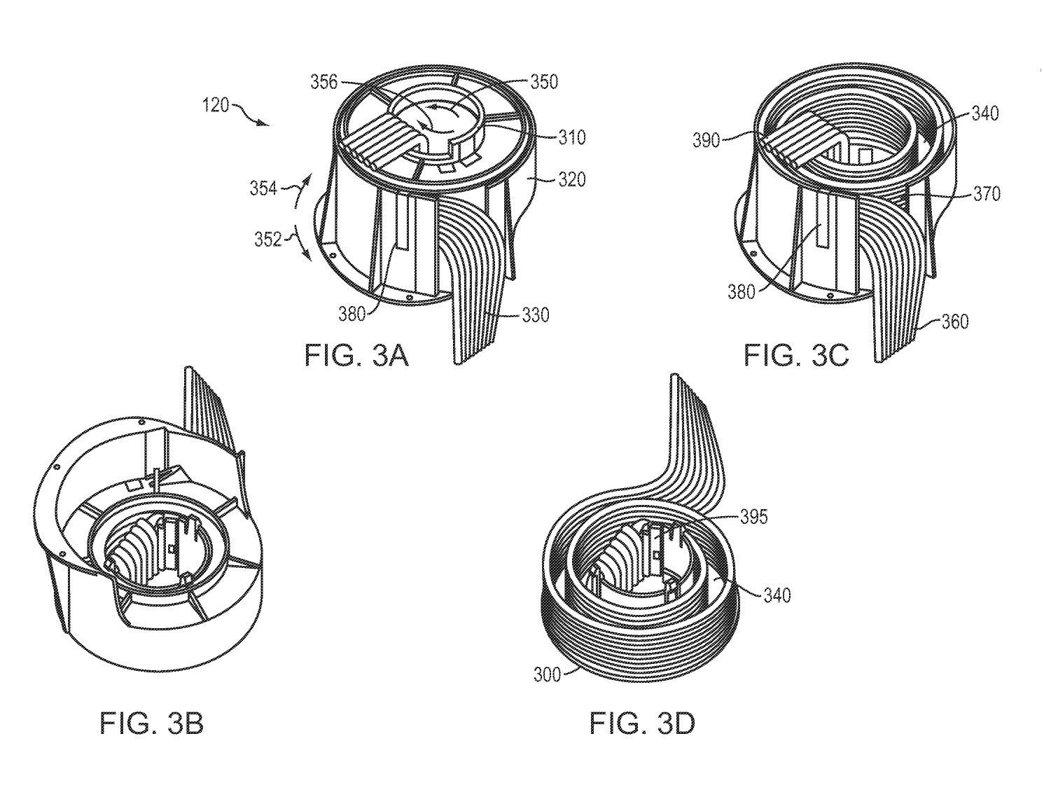

The clock-spring cable-management system described above may also be used in a twist joint 120. For example, with reference to FIGS. 3A-3D, a twist joint 120 may include two cylinders, an inner cylinder (or inner mandrel) 310 and an outer cylinder (or outer sleeve) 320. The cylinders may be rotatable relative to one another or one may be static. In one embodiment, the inner mandrel 310 and outer sleeve 320 are concentric. A cable 330 is wound spirally in the space 340 between the inner mandrel 310 and outer sleeve 320, as depicted in FIGS. 3C and 3D. Movement of the joint 120 may involve rotation of the inner mandrel 310 in a direction 350, and the outer sleeve 320 may remain in a static position. Similarly, when joint 120 twists in the other direction, the inner mandrel 310 rotates in the direction indicated at 356 and the outer sleeve 320 again may remain static. In some embodiments, when joint 120 twists, the inner mandrel or outer sleeve remains in a static position while the other member rotates. As a result of the net cylindrical rotation, the cable 330 is either drawn around the outer surface of the inner mandrel 310 or expanded against the inner surface of the outer sleeve 320. In another embodiment, the rotational axes of the inner mandrel 310 and the outer sleeve 320 are offset. When there is a net cylindrical rotation, one section of the cable 330 is wrapped against the outer surface of the inner mandrel 310 while another section of the cable 330 is unwrapped therefrom. Again, this mechanism significantly reduces the required cable length passing through the twist joints. Because the twist momentum of the twist joint is transferred to the rotational momentum of the cylinder(s) that results in pulling or expanding the cable 330 spiral in the space 340, the clock-spring system avoids twisting the cable 330. Additionally, because the bend radius of the cable 330 varies only between the outside diameter of the inner mandrel 310 and the inside diameter of the outer sleeve 320, the deformation of the cable 320 during joint twisting is limited.

To fit the clock-spring cable-management system 300 into a limited packaging space of the twist joint 120, a compact folding design for the cable entering and/or exiting the clock-spring system may be employed. In one embodiment, the cable folding design for passing through the twist joint 120 may be similar to that described above in connection with FIGS. 2A and 2B. In another embodiment, as illustrated in FIGS. 3A and 3B, the outer sleeve 320 and the inner mandrel 310 may each include a slot for cable 330 to enter and exit the joint 120. In one embodiment, the cable 330 is aligned with the axis of rotation before entering the joint 120, as shown by the cable region 360 in FIG. 3C. The cable 330 enters the joint 120 first by bending at a bending angle and then twisting at a twisting angle to pass through the slot 370 through the outer sleeve 320. After passing through the slot 370, the cable 330 is wound spirally in the space 340 between two cylinders. The bending angle and twisting angles, for example, may be 90° and 45°, respectively; however, other angles providing compact cable folding are within the scope of the current invention.

In some embodiments, a retaining clip 380 attached or incorporated onto the outer sleeve 320 confines the lateral motion of the cable. Similarly, when cable 330 exits the joint 120, the cable first twists 90° to enter a slot at the base of the inner mandrel 310, turning 180° to rise upward and exit the joint, finally turning 90° to extend away from the joint axis of rotation and the joint 120 itself as depicted in the cable region 390 in FIG. 3C. If the cable is wide and flat (e.g., like a ribbon cable) and thus difficult to rotate (or bend in the plane of the cable) uniformly, at least one longitudinal slit may be cut into the cable jacket along the space between the insulated conductors; this allows different bending deformations in the plane of the cable as well as rotation of the entire cable with an angle. In various embodiments, the inner mandrel 310 may include a retaining clip 390 for confining the lateral motion of the cable before exiting the joint 120.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A cable-management system facilitating rotation from a first angular position to a second angular position without damage to the cable, the system comprising:
inner and outer cylinders; and
a cable wound spirally in a space between the inner and outer cylinders,
wherein at least a section of the cable is configured to wrap around an outer surface of the inner cylinder at the first angular position and to unwrap from the outer surface of the inner cylinder at the second angular position.

2. The cable-management system claim 1, wherein at least one of the cylinders is rotatable relative to the other between the first angular position and the second angular position.

3. The cable-management system of claim 1, further comprising a slot in the inner cylinder and a slot in the outer cylinder.

4. The cable-management system of claim 3, wherein a first end of the cable twists to pass through the slot in the inner cylinder.

5. The cable-management system of claim 3, wherein the cable passes through the slot in the outer cylinder and exits the outer cylinder at an angle relative to a plane tangent to the outer cylinder.

6. The cable-management system of claim 5, wherein the angle is less than 45°.

7. The cable-management system of claim 1, wherein the outer cylinder further comprises a retaining clip to confine lateral movement of the cable.

8. The cable-management system of claim 1, wherein the inner cylinder further comprises a retaining clip to confine lateral movement of the cable.

9. The cable management system of claim 1, wherein the inner and outer cylinders are concentric.

10. The cable management system of claim 1, wherein a rotational axis of the inner cylinder and a rotational axis of the outer cylinder are offset with respect to each other.

11. A method of rotating a cable within a joint from a first angular position to a second angular position without damage to the cable, the joint having inner and outer cylinders capable of net relative rotation, the cable being wound spirally in a space between the inner and outer cylinders, method comprising the steps of:
executing a rotation of the joint in a first direction whereby at least a first section of the cable wraps around an outer surface of the inner cylinder, and
executing a rotation of the joint in a second direction whereby the first section of the cable unwraps from the outer surface of the inner cylinder.

12. The method of claim 11, wherein at an end point of the rotation in the first direction, the cable is tightly wrapped around the outer surface of the inner cylinder.

13. The method of claim 11, wherein at an end point of the rotation in the second direction, the cable is urged against the inner surface of the outer cylinder.

14. The method of claim 11, wherein in the first rotational direction, at least a second section of the cable unwraps from the outer surface of the inner cylinder.

15. The method of claim 14, wherein in the second rotational direction, the second section of the cable wraps around the outer surface of the inner cylinder.
